(19) United States
(12) Patent Application Publication
(10) Pub. No.: US 2002/0041671 A1
(43) Pub. Date: Apr. 11, 2002

(54) Arrangement for processing data in a telecommunications network and a method for setting up a telecommunications data processing arrangement

(76) Inventors: Koen Schilders, Riel (NL); Barend Kruijf, Leiden (NL); Eelco Nicodem, Zwijndrecht (NL)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/767,726

(22) Filed: Jan. 24, 2001

(30) Foreign Application Priority Data
Jan. 25, 2000 (WO) PCT/EP/00639

(51) Int. Cl. H04M 3/00; H04M 5/00

(52) U.S. Cl. 379/242

(57) ABSTRACT

This invention relates to switching and operational support systems in the area of general telecommunications, and more particularly, to a new type of telecommunications data processing arrangement, and to a new type of solution for setting up a telecommunications data processing arrangement. The solution according to the invention can be applied for example in design, development and implementation of new data processing applications.

This invention relates to switching and operational support systems in the area of general telecommunications, and more particularly, to a new type of telecommunications data processing arrangement, and to a new type of solution for setting up a telecommunications data processing arrangement.

A telecommunications network consists of multiple network elements such as telephony switches, gateways or service nodes. A telephony switch, for instance, is used to switch speech and data signals coming from another part of network. While performing this function the switch also generates a lot of data, which is then used for different purposes e.g. billing the customer for the phone call, billing another operator for the use of the network, or statistical data handling.

In an ordinary telecommunications network the data from different network elements is collected by different mediation devices and then forwarded to different operational support system applications such as customer billing application, customer care application or fraud analysis application. Current telecommunication data processing arrangements however are usually built towards the needs of each new application.

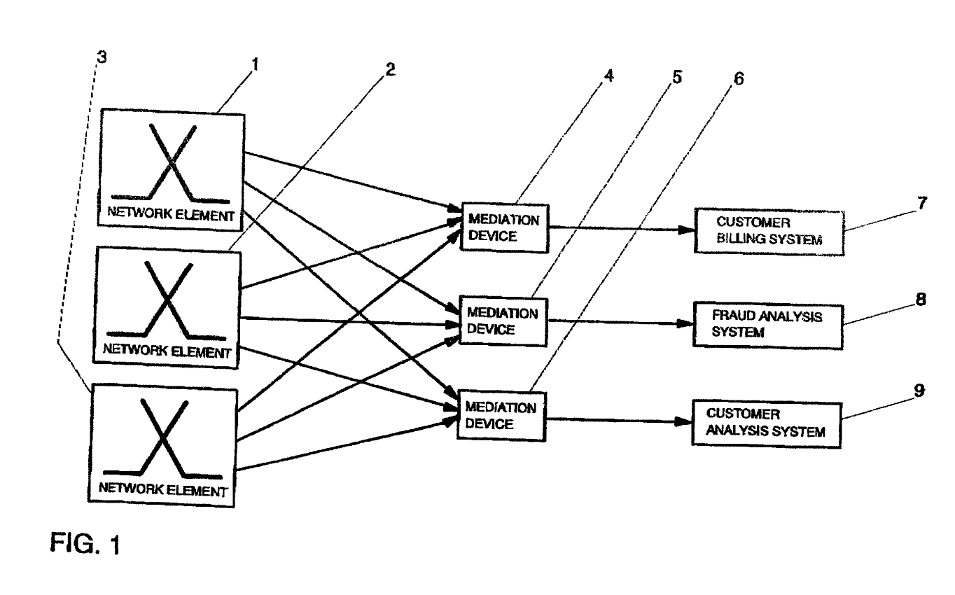

In the following, the prior art solutions will be described in more detail with reference to the accompanying FIG. 1 which is a block diagram showing a telecommunications data processing arrangement according to prior art.

FIG. 1 shows a block diagram of a telecommunications data processing arrangement according to prior art. A telecommunications data processing arrangement according to prior art comprises network elements 1-3, which produce event data. The data from network elements 1-3 is collected by mediation devices 4-6 and then forwarded to different operational support systems 7-9 such as customer billing system 7, fraud analysis system 8 or customer care system 9.

The information collected from the network elements 1-3 is usually processed by the mediation devices 4-3 to the format required by the respective operational support systems 7-9. The operational support system applications 7-9 such as customer billing system application 7, fraud analysis system application 8 or customer care system application 9 then use this information, for example, in their analyses.

When new operational support system applications 7-3 are introduced or new requirements are placed on the existing operational support system applications 7-3, there is a lot of changes required in the network. These changes need to be carried out in the data processing applications, i.e. the mediation devices 4-6, in addition to the required changes in the existing operational support system applications 7-9 . This updating of the different elements in the telecommunications network environment is an extremely troublesome and time-consuming operation.

The data processing arrangements according to the prior art are very inflexible and thus do not provide an adequate solution for the necessary changes in the environment. Further the data processing arrangements according to the prior art are very restricted in the type of changes that are possible as well as in how these changes can be carried out. There is no known solution available that would provide an adequate solution for the necessary changes in the environment to be easily carried out.

There are also several problems related to the control of a network of data-processing components. As each of the components have different capacity of handling data, there could occur loss of data when a component receives more data than it can handle. When there are changes in the architecture there is a lot of work needed in the system such as e.g. introduction of new processes.

When a change also involves a change in the structure of input data, the components need to be updated to handle this new data, but only if all the old data is processed before the new data arrives. If components reject input data there might be appropriate actions needed in case dataloss is not allowed.

In the view of the prior art there is a clear need for a new type of a telecommunications data processing arrangement and a new type of method for setting up a telecommunications data processing arrangement that would allow changes to be carried out in the arrangement without having to build or re-build telecom data-processing applications. Since the application will be deployed in a telecom environment, an uptime of close to 100% is required. This means that the telecommunications data processing arrangement should support changes to the connections between the data processing components also to be made at runtime. Lack of such a solution has already for a quite some time been a stumbling block for the further development of the current operational support system applications.

The aim of this invention is to overcome the drawbacks of the prior art solutions and to provide a new type of telecommunications data processing arrangement and a new type of method for setting up a telecommunications data processing arrangement.

According to the first aspect of the present invention there is provided an arrangement for processing data in a telecommunications network, comprising one or more network elements, and operational support systems, which arrangement is characterized by that the arrangement further comprises a data processing network element, so that the network elements produce the event data and deliver this data as input signal data to the data processing network element, and that the data processing network element processes the inputted data and generates an output signal data towards the different operational support systems, the arrangement being further characterized in that the data processing components of the data processing network element have a generic component interface and that the arrangement has a flexible architecture for combining the data processing components together, where the data processing components are linked together at the startup-time of the telecommunications data processing arrangement. There is also provided a method for setting up a telecommunications data processing arrangement in a telecommunications network, where the network elements are producing event data used by different operational support systems, which is characterized by that the arrangement further comprises a data processing network element for processing the input data from the network elements and generating an output data towards the operational support systems, in which a flexible architecture between the data processing components, having a generic component interface, is set up by exporting the properties of the available data processing components within the telecommunications data processing arrangement, by parsing a configuration file of the telecommunications data processing arrangement, and by linking the data processing components together at the startup-time of the telecommunications data processing arrangement.

A more complete understanding of the method and the arrangement of the present invention may be obtained by the preferred embodiments that follow, taken in conjunction with the accompanying drawings, wherein:

FIG. 1 is a block diagram of a telecommunications data processing arrangement according to prior art,

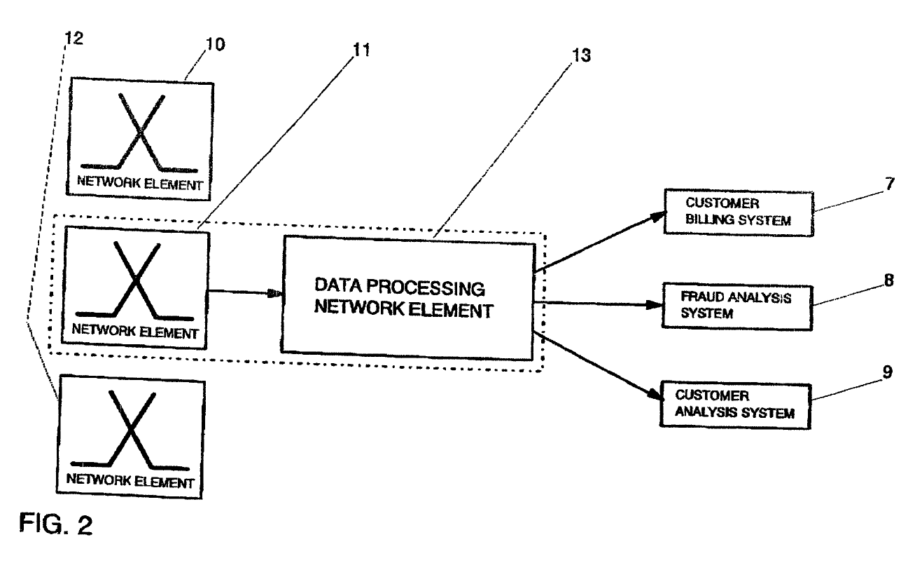

FIG. 2 is a block diagram of a telecommunications data processing arrangement according to the present invention,

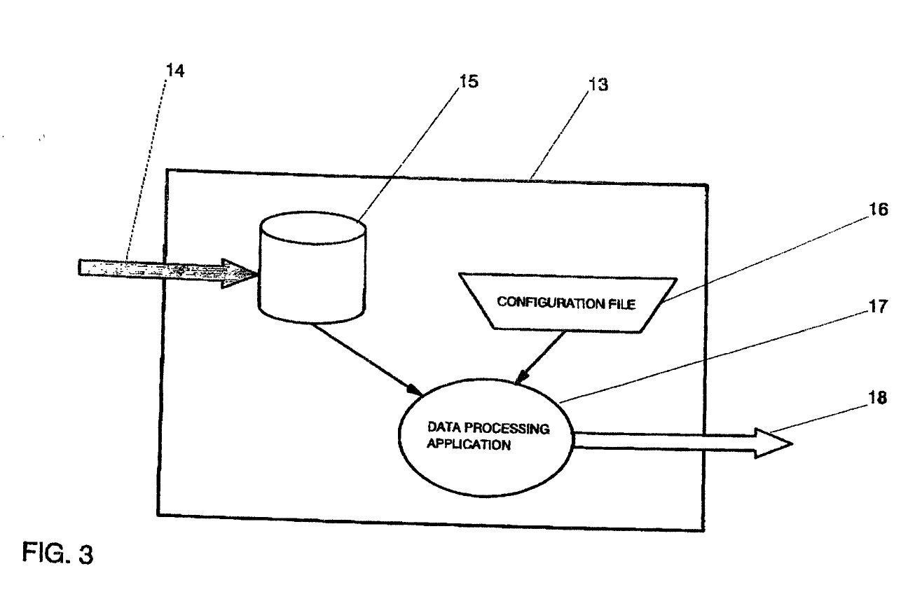

FIG. 3 is a block diagram flexible architecture solution of a telecommunications data processing arrangement according to the present invention,

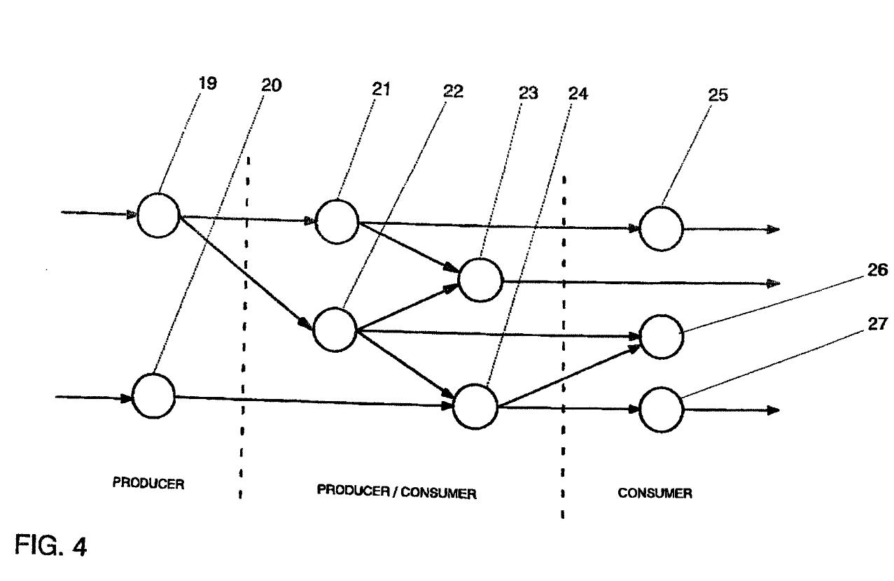

FIG. 4 is a diagram of an example of data processing component connections in a telecommunications data processing arrangement according to the present invention.

The prior art solutions have been described in drawing 1. In the following, the solution according to the present invention will be described in more detail with reference to the accompanying drawings 2-3.

FIG. 2 shows a block diagram of a telecommunications data processing arrangement according to the present invention. A telecommunications data processing arrangement according to the present invention comprises network elements 10-12, a data processing network element 13 and operational support systems 7-9, such as customer billing system 7, fraud analysis system 8 or customer care system 9. The network elements 10-12 can, for example, consist of telephony switches, gateways and service nodes.

The network elements 10-12 produce the event data and deliver this data as input signal data to the data processing network element 13. The data processing network element 13 then processes the inputted data and generates an output signal data towards the different operational support systems 7-9. The data processing network element 13 may be co-located with one network element 11, as shown in the figure by means of a dotted box, and thus only process the input signal from that element 11. When the data processing network element 13 is not co-located with one network element, it processes the input signal from one or more network elements.

The telecommunications data processing arrangement according to the present invention consists of a flexible data processing component architecture combined with a generic component interface. The data processing arrangement solves the problem of having to build or re-build telecom data-processing applications for every new customer with needs for a new data-processing product, or for every major change in requirements customers have on a data-processing product they already own and use.

In the data processing arrangement according to the present invention the making of changes to the connections between the data processing components are supported also at runtime, which is important as the arrangement is deployed in a telecom environment.

In the data processing arrangement according to the present invention, the data processing components of the data processing network element 13 have a generic component interface, which is capable of handling the data transfers independent from the type of data. In a solution according to the present invention, when a certain requirement cannot be met with a combination of the existing data processing components that are available within the application as a standard, a new component can easily be added. This also benefits other future customers with a similar requirement. The connections necessary to be made are based on configuration information that is tailored to fit the requirements of the customer.

FIG. 3 shows a block diagram flexible architecture solution of a telecommunications data processing arrangement according to the present invention. In the figure the data processing network element is marked with a reference number 13. The data processing network element 13 according to the present invention has a database 15, a configuration file 16 and a data processing application 17.

The data processing network element 13 has a database 15 into which the incoming input 14 is stored until it is processed. The data processing application 17 will use the incoming input 14 from the database 15 and the information from the configuration file 16 of the application to process the data. The processing application 17 will then generate an output signal 18 towards the operational support system applications.

FIG. 4 shows a diagram of an example of data processing component connections in a telecommunications data processing arrangement according to the present invention. In a telecommunications data processing arrangement according to the present invention there are three types of components can be distinguished within the data processing system, producer data processing components 19, 20, producer/consumer data processing components 21-24 and consumer data processing components 25-27.

Producer data processing component 19, 20 is a component which communicates with an external entity. Producer data processing component 19, 20 is used for receiving input, and it produces data towards the producer/consumer data processing components 21-24. Producer/consumer data processing component 21-24 is a component that consumes data internally to the system, and produces a transformed form of that data towards the consumer data processing components 25-27. Consumer data processing component 25-27 is a component that communicates with an external entity for the delivery of the output data.

In a telecommunications data processing arrangement according to the present invention is based on a generic data processing component interface and a new architecture solution for combining the data processing components together. The generic data processing component interface consist of the following concepts:

adapters that are the interface between the different data processing components and accomplish the connection between them,

synchronization support arrangement for the cases when certain components cannot handle the datarate,

check/back-up support arrangement for the different data processing components, and

configuration change support arrangement.

In a telecommunications data processing arrangement according to the present invention the adapters can cross boundaries between process and machines when necessary. In the synchronization support arrangement according to the present invention when certain components cannot handle the datarate, this is signalled back to the components producing the data. This way part of the system is blocked until the blocking condition is ceased. The reason for blocking a part of the system is achieving increased reliability of the telecommunications data processing arrangement.

The check/back-up support arrangement according to the present invention is used to further increase the reliability. In the arrangement every data processing component registers with a checkpoint component and feeds it at a regular basis, e.g. every 5 seconds, with information stating which data it has processed and safely passed on to the next component without getting lost or duplicated. The check/back-up support arrangement flushes this information to disk at a regular interval. If the system crashes, the check/back-up support arrangement distributes this information over all data processing components which can than continue processing the data exactly at the point of the crash.

When new type of input data has to be processed or when new type of output has to be generated, the configuration change support arrangement according to the present invention is used to prevent old type of data being mixed with new type of data. The input sources are blocked and the system is flushed in the front-to-back order. After detecting that the entire system is flushed, the system is restarted, the new configuration is picked up by the data processing components, and the processing the new type of data is started.

In a telecommunications data processing arrangement according to the present invention the component interface is very flexible. The data processing software components can be physically located in different locations such as in a same process on the same computer, in multiple processes on the same computer, or in multiple processes on multiple computers.

The flexible architecture solution for combining the data processing components together in a telecommunications data processing arrangement according to the present invention is based on a solution, where the data processing components are linked together at the startup-time or run-time of the telecommunications data processing arrangement. These data processing components can be used to build new component clusters and new data processing applications.

The flexible architecture solution according to the present invention is set up as follows:

within the telecommunications data processing arrangement, the available data processing components export their properties, which among others contain the component parameters and the component name,

a configuration file 16, which dictates which components should be linked up with each other, is parsed at startup-time or during run-time of the telecommunications data processing arrangement.

The configuration information dictates the internal build-up of the data processing components within the data processing application. The component link-up configuration file 16 is processed at the start-up of the data processing application.

When the telecommunications data processing arrangement needs to reconfigure itself during run-time, an external signal is send to the telecommunications data processing arrangement to inform it that the end-user wants the arrangement to re-read the configuration it has prepared.

In the flexible architecture solution according to the present invention the components can be listed in one or more component galleries based on the component name.

The validity of a certain component link-up is checked based on the properties of the components in question. Such a configuration file 16 can be specified in a specially defined language. The language used can be for example Network Definition Language, NDL. Following is an example of component link-up configuration file 16

Fileblocker fb();
Blocker b(size = s);
Printer p();
//connect components together
fb−>b−>p;

The example above shows an application using three components; a FileBlocker, a Blocker and a Printer processing component. These names must match one of the components present in the gallery. The line ‘fb->b->p’ links together instantiations of these components to form what is called a network. Based on the individual properties of the components it is checked whether they can be linked together in the configured way. Data presented to component instantiation ‘fb’ will now be processed by ‘fb’ and passed on to the next component ‘b’ in the chain and so on.

Changes to the configuration can be made any time and as soon as the telecommunications data processing arrangement is restarted, it is picked up and in essence a new telecommunications data processing arrangement with new behaviour is born.

In a telecommunications data processing arrangement according to the present invention there is a possibility to combine different data processing components together to build new components, component clusters.

Data processing component clusters are usually formed when only a combination of existing data processing components can lead to the required functionality. These data processing components are then linked together to form a new component, component cluster. A data processing component cluster can be multiple levels deep and contain other component clusters. Following is an example of a data processing component cluster built of other data processing components

//instantiate a file reader component
FileReader fr;
//define a cluster using type name “Stream”
component Stream (Unsigned s = 100)
{

Fileblocker fb();
Blocker b(size = s);
Printer p();
ObjectCounter c();
//connect components within this cluster
fb−>b−>p;
b−>c;
//define input and output of this cluster
input fb;
output b;

}
//instantiate the cluster “Stream” three times
Stream s1(s = 50);
Stream s2(s = 200);
Stream s3(); //uses default argument s = 100
//connect file reader to instantiated streams
fr−>s1;
fr−>s2;
fr−>s3

The above example shows a data processing component cluster which is used three times in the resulting application to form a network of components. All of them get their input from component ‘fr’ but behave differently because of the parameter that is passed to them.

With the help of the solution according to the present invention the design, development and implementation of new data processing applications is considerably easier. Also the maintenance of the data processing arrangements can be considerably improved. The generic components according to the present invention can be made part of a reusable component library for building different data processing applications such as for example charging and billing applications, data warehouse applications, mediation applications and any other operational support system applications.

What is claimed is:

1. An arrangement for processing data in a telecommunications network, comprising one or more network elements (10)-(12), and operational support systems (7)-(9), characterized in that the arrangement further comprises a data processing network element (13), so that
the network elements (10)-(12) produce the event data and deliver this data as input signal data to the data processing network element (13), and that
the data processing network element (13) processes the inputted data and generates an output signal data towards the different operational support systems (7)-(9), the arrangement being further characterized in that the data processing components of the data processing network element (13) have a generic component interface and that the arrangement has a flexible architecture for combining the data processing components together, where the data processing components are linked together at the startup-time of the telecommunications data processing arrangement.

2. A telecommunications data processing arrangement according to claim 1, characterized in that at the start-up of the data processing arrangement there is processed a component link-up configuration file (16), which dictates the internal build-up of the data processing components within the data processing arrangement.

3. A telecommunications data processing arrangement according to claim 1 or claim 2, characterized in that the data processing components are linked together at the run-time of the telecommunications data processing arrangement.

4. A telecommunications data processing arrangement according to claim 3, characterized in that there is an external signal sent to the telecommunications data processing arrangement when the component link-up configuration file (16) needs to be re-read.

5. A telecommunications data processing arrangement according to claim 1 or claim 3, characterized in that the data processing arrangement is designed so that a new data processing component can easily be added.

6. A telecommunications data processing arrangement according to claim 5, characterized in that the components are listed in one or more component galleries based on the component name.

7. A telecommunications data processing arrangement according to any of the claims 1, 3, 5 or 6, characterized in that the validity of a component link-up is checked based on the properties of the components in question.

8. A telecommunications data processing arrangement according to claim 1 or claim 3, characterized in that the data processing network element (13) is co-located with one network element (11).

9. A telecommunications data processing arrangement according to claim 1 or claim 3, characterized in that the data processing network element (13) has
a database (15), into which the incoming input (14) is stored until it is processed,
a configuration file (16), and
a data processing application (17), which will use the incoming input (14) from the database (15) and the information from the configuration file (16) of the application to process the data and to generate an output signal (18) towards the operational support system applications.

10. A telecommunications data processing arrangement according to claim 1, claim 3 or claim 9, characterized in that in the arrangement there are three types of components:
producer data processing components (19), (20), which communicate with an external entity, are used for receiving input, and which produce data towards the producer/consumer data processing components (21)-(24),
producer/consumer data processing components (21)-(24), which consume data internally to the system, and produce a transformed form of that data towards the consumer data processing components (25)-(27),
consumer data processing components (25)-(27), which communicate with an external entity for the delivery of the output data.

11. A telecommunications data processing arrangement according to any of the claims 1, 3, 9 or 10, characterized in that the generic data processing component interface consists of adapters that are the interface between the different data processing components and accomplish the connection between them.

12. A telecommunications data processing arrangement according to claim 11, characterized in that the adapters can cross boundaries between process and machines when necessary.

13. A telecommunications data processing arrangement according to claim 11, characterized in that the generic data processing component interface further comprises a configuration change support arrangement, which is used to prevent old type of data being mixed with new type of data.

14. A telecommunications data processing arrangement according to claim 11 or claim 13, characterized in that the generic data processing component interface further comprises a synchronization support arrangement, which sends a signal to a component producing the data, when a components cannot handle the datarate.

15. A telecommunications data processing arrangement according to claim 11, claim 13 or claim 14, characterized in that the generic data processing component interface further comprises a check/back-up support arrangement, in which every data processing component registers with a checkpoint component and feeds the checkpoint component on a regular basis with information stating which data the data processing component has processed and safely passed on to the next component.

16. A telecommunications data processing arrangement according to any of the preceding claims 1-15, characterized in that data processing software components are located in a same process on the same computer.

17. A telecommunications data processing arrangement according to any of the preceding claims 1-15, characterized in that data processing software components are located in multiple processes on the same computer.

18. A telecommunications data processing arrangement according to any of the preceding claims 1-15, characterized in that data processing software components are located in multiple processes on multiple computers.

19. A telecommunications data processing arrangement according to any of the preceding claims 1-18, characterized in that different data processing components are combined together to build new data processing component clusters.

20. A telecommunications data processing arrangement according to claim 19, characterized in that a data processing component cluster is multiple levels deep.

21. A telecommunications data processing arrangement according to claim 20, characterized in that a data processing component cluster contains other component clusters.

22. A telecommunications data processing arrangement according to any of the preceding claims 1-21, characterized in that the generic components according to the present invention are made part of a reusable component library.

23. A method for setting up a telecommunications data processing arrangement in a telecommunications network, where the network elements (10)-(12) are producing event data used by different operational support systems (7)-(9), characterized in that the arrangement further comprises a data processing network element (13) for processing the input data from the network elements (10)-(12) and generating an output data towards the operational support systems (7)-(9), in which a flexible architecture between the data processing components, having a generic component interface, is set up by
exporting the properties of the available data processing components within the telecommunications data processing arrangement, by
parsing a configuration file (16) of the telecommunications data processing arrangement, and by
linking the data processing components together at the startup-time of the telecommunications data processing arrangement.

24. A method according to claim 23, characterized in that at the start-up of the data processing arrangement there is processed a component link-up configuration file (16), which dictates the internal build-up of the data processing components within the data processing arrangement.

25. A method according to claim 23 or claim 24, characterized in that the data processing components are linked together at the run-time of the telecommunications data processing arrangement.

26. A method according to claim 25, characterized in that there is an external signal sent to the telecommunications data processing arrangement when the component link-up configuration file (16) needs to be re-read.

27. A method according to claim 23 or claim 25, characterized in that the components are listed in one or more component galleries based on the component name.

28. A method according to claim 23, claim 25 or claim 27, characterized in that the validity of a component link-up is checked based on the properties of the components in question.

29. A method according to any of the preceding claims 23-28, characterized in that the component link-up configuration file (16) is specified in a specially defined language.

30. A method according to any of the preceding claims 23-29, characterized in that different data processing components are combined together to build new data processing component clusters.

31. A method according to claim 30, characterized in that a data processing component cluster is multiple levels deep.

32. A method according to claim 31, characterized in that a data processing component cluster contains other component clusters.

33. A method according to any of the preceding claims 23-32, characterized in that the generic components according to the present invention are made part of a reusable component library.
